(19) United States
(12) Patent Application Publication
(10) Pub. No.: US 2025/0071389 A1
(43) Pub. Date: Feb. 27, 2025

(54) System and Method for Capturing and Sharing Real-Time First Person Perspective And Content Creator Platform

(71) Applicant: Travon Taylor, Henderson, NV (US)

(72) Inventor: Travon Taylor, Henderson, NV (US)

(21) Appl. No.: 18/809,404

(22) Filed: Aug. 20, 2024

Related U.S. Application Data
(60) Provisional application No. 63/533,723, filed on Aug. 21, 2023.

(51) Int. Cl. H04N 21/80; G06F 3/01; G06Q 20/12; H04N 21/2187; H04N 21/266; H04N 21/4223; H04N 23/90

(52) U.S. Cl. CPC H04N 21/80; G06F 3/012; H04N 21/2187; H04N 21/266; H04N 21/4223; H04N 23/90; G06Q 20/12

(57) ABSTRACT

A platform and method for sharing a first-person perspective of experiences from a content creator to multiple users in real time. The platform includes a capture set with sensors and a transceiver, a server, and a cloud-based application. The sensors capture environmental information, which is transmitted to the server to create a content package conveying the first-person perspective. This package is relayed to the users' content displays via the cloud-based application. The platform can tailor the content package to the hardware configuration of each user's content display for a realistic reproduction of the first-person perspective. The platform allows users to interact with the content creator during the experience, creating a shared experience. The platform also includes a payment portal for the content creator to design and implement payment terms for access to the content package.

### BACKGROUND OF THE INVENTION

### Cross Reference

The present application claims the benefit under 35 U.S.C. 119 of U.S. Provisional Patent Application Ser. No. 63/533,723 filed Aug. 21, 2023. The U.S. Provisional Patent Application Ser. No. 63/533,723 is hereby incorporated by reference in its entirety.

### Field of the Invention

The present invention pertains to the field of augmented reality (AR) technology and content creation platforms. More specifically, it relates to a novel system comprising augmented reality glasses and an associated platform that enables users to immerse themselves in a real-time, first-person perspective experience generated by content creators.

### Description of Related Art

Modern technology has ushered in an era of immersive experiences and content creation. Augmented reality has emerged as a transformative technology, offering users the ability to overlay digital elements onto their real-world environment. Wearable devices, including augmented reality glasses, have gained prominence by enabling users to access and interact with digital content while maintaining their physical presence. Additionally, the rise of content creation and sharing platforms has empowered individuals to produce a diverse range of content, from educational tutorials to entertainment experiences. Content creation and sharing platforms have revolutionized the way individuals share their experiences and expertise with a global audience. However, the challenge lies in capturing and conveying the true essence of dynamic and adventurous activities, where the content creator's first-person perspective holds intrinsic value. Current content consumption methods often lack the immersive and authentic engagement that comes with experiencing content from the creator's perspective.

Body mountable cameras including GoPro style cameras and camera glasses exist that record video and store information on a memory drive for later viewing. Virtual and augmented reality glasses have already entered the market, providing users with the means to view digital information overlaid on their real-world surroundings, utilizing a combination of sensors, cameras, and processing units to analyze the environment and present relevant digital content to the user. Content creation platforms, on the other hand, enable users to generate, upload, and share various forms of content, such as videos, live streams, and interactive experiences from mobile devices like mobile phones and tablets. While these platforms offer unique opportunities for content creators to showcase their skills and insights, they do not fully capture the visceral experience of the creator's point of view in real time.

In recent years, the realm of content creation has witnessed the rise of a dynamic and engaging form of storytelling known as live travel blogging. This emerging trend involves content creators, often explorers and adventurers, who embark on journeys to captivating destinations while sharing their real-time experiences through digital platforms. Live travel bloggers utilize various media formats, including live video streams and multimedia updates, to provide their audiences with an intimate and unfiltered glimpse into their explorations.

Despite the advancements in augmented reality and content creation technologies, a notable gap remains in enabling users to experience content from the content creator's perspective as if they were “seeing through their eyes.” There exists a gap in capturing and sharing the raw and thrilling experience of content creators engaged in dynamic and adventurous activities. Existing methods often rely on third-party camera setups that may lack the immediacy and authenticity of the content creator's genuine point of view. There is a need for hardware and a related platform that seamlessly combines virtual or augmented reality glasses with a real-time sharing platform, enabling users to connect with content creators' experiences in an unparalleled and immersive manner. Similarly, there is a need for content creators to more directly involve and engage content consumers, fostering a new level of engagement and interaction between creators and their audiences.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

BRIEF SUMMARY OF THE INVENTION

The present invention provides among other things a content sharing platform, and more specifically a system and method for capturing and sharing first-person perspective experiences in real time. The invention further relates to the customization of content packages based on the hardware configuration of user devices, and the provision of interactive and monetization features for content creators.

It is an object of the invention to create wearable glasses featuring integrated capture technology.

It is another object of the invention to allow content creators participating in adventurous activities, equipped with advanced cameras, sensors, and data-capturing components to accurately record their first-person perspective, encompassing visual, auditory, and sensory elements.

It is another object of the invention to develop a real-time content sharing platform tailored explicitly for showcasing the real-time experiences of content creators.

It is another object of the invention to provide a platform granting users with immediate access to live video feeds and immersive multimedia content captured by content creators using the glasses.

It is another object of the invention to provide seamless transmission, processing, and delivery of a content creator's perspective.

It is another er object of the invention to establish a wireless data transmission infrastructure that ensures swift and uninterrupted transfer of captured content from the glasses to the content sharing platform.

It is another object of the invention to minimize latency and maintain high-quality transmission standards, thereby enabling users to engage with the content creator's perspective in real time without disruptions.

It is another object of the invention to design a user interface that empowers users to interact with, customize, and navigate their experience while immersing themselves in the content creator's perspective.

It is another object of the invention to allow users to switch between content creators, adjust visual settings, and access supplementary information pertaining to the ongoing activity.

It is another object of the invention to establish a content creator authentication and management system to ensure authorized use of the glasses and participation on the platform.

It is another object of the invention to manage user profiles, access permissions, and content scheduling, streamlining the process of sharing real-time experiences and maintaining the integrity of the user base.

It is another object of the invention to explore the integration of the augmented reality glasses with wearable technologies, including biometric sensors and location tracking devices.

It is another object of the invention to introduce immersive social interaction features, facilitating real-time engagement between users, content creators, and other viewers.

It is another object of the invention to establish monetization and revenue generation mechanisms for content creators.

It is another object of the invention to implement subscription models, pay-per-view options, advertising integration, and revenue-sharing arrangements to incentivize content creation, sustain user engagement, and ensure the platform's financial viability.

The above and other objects may be achieved using devices involving a platform that enables the sharing of first-person experiences from a content creator to multiple users in real time. The platform comprises a capture set, a server, and a cloud-based application. The capture set includes a variety of sensors that gather environmental information and a transceiver. The server, in wireless communication with the transceiver, receives the information from the sensors and creates a content package that conveys the first-person perspective of the content creator. The server may communicate with the capture set via an application on the content creator's mobile device. The cloud-based application then relays the content package to the content displays of multiple users.

In certain embodiments, the platform tailors the content package to realistically reproduce the first-person perspective at the content display based on the hardware configuration of the content display. The sensors may include at least one camera configured to capture environmental information near the eyes of the content creator, and at least one microphone configured to capture environmental information near the ear of the content creator. In some instances, the capture set may be a pair of glasses housing the camera and microphone.

The content display can be a desktop monitor and speakers, a virtual reality headset, or a mobile device display. The platform allows users to interact with the content creator during the experience, and these interactions are reproduced at each content display of the users to create a shared experience. The platform also includes a payment portal that allows the content creator to design and implement payment terms for access to the content package.

A method for sharing a first-person perspective of an experience to multiple users in real time is also provided, which includes capturing the environmental information about the experience through the sensors, transmitting the information to the server, creating a content package, and relaying the content package to the content display of each user. The method may also include providing a payment portal that allows the content creator to design and implement payment terms for access to the content package, restricting access to the content package, and providing the content package on demand when the payment terms have been satisfied.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a graphical representation of the basic elements of the platform according to one or more embodiments of the invention.

FIG. 2 depicts a capture set used in connection with the platform according to one or more embodiments of the invention.

FIG. 3a-d depicts multiple views of the capture set depicted in FIG. 2.

FIG. 4 depicts an exploded view of a capture set used in connection with the platform according to one or more embodiments of the invention.

FIG. 5 depicts an exploded view of a charging case for the capture set depicted in FIG. 4.

FIG. 6 depicts a schematic view of various control functions for the capture set depicted in FIG. 4.

FIG. 7a depicts a flow chart showing the functions of the platform according to one or more embodiments of the invention.

FIG. 7b depicts a continuation of FIG. 7a of a flow chart showing the functions of the platform according to one or more embodiments of the invention;

FIG. 8 depicts another embodiment showing an example setup of the platform in accordance to one or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

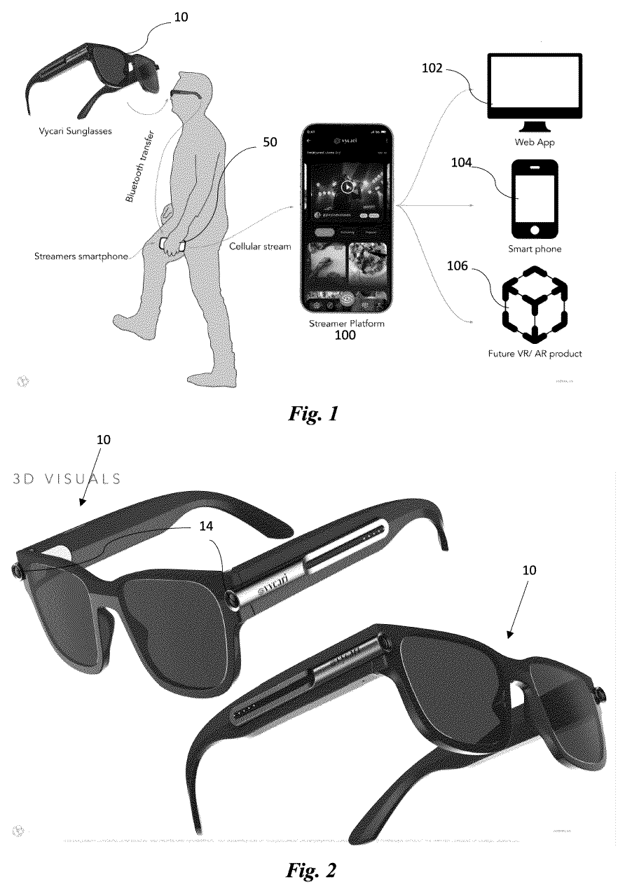

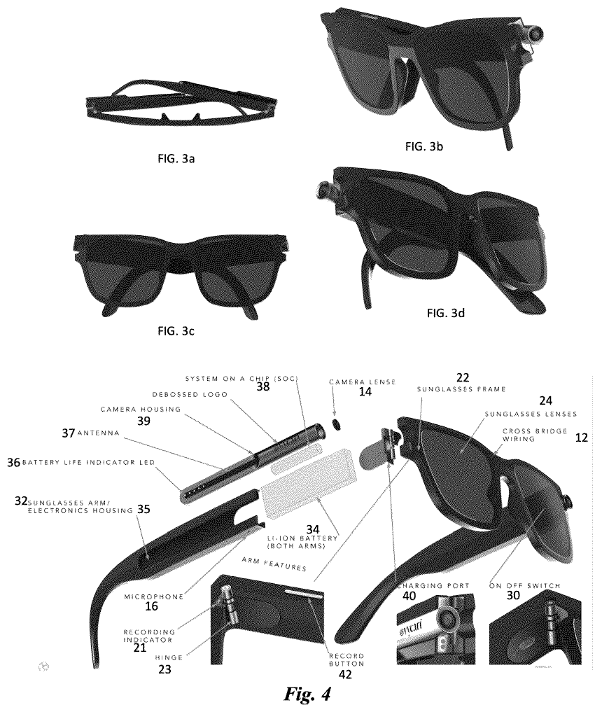

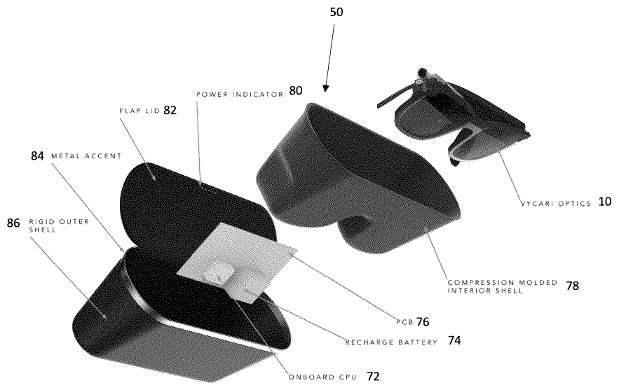

Referring to FIGS. 1-4, in one application of the invention, a wearable capture set 10 can capture the viewpoint of a content creator to be shared over a platform 100. The wearable capture set 10 may take the form of a pair of glasses 12, such as prescription glasses, non-prescription glasses or sunglasses and may include one or more cameras 14, one or more microphones 16, and other sensors to capture environmental features such as temperature, pressure, humidity, moisture, GPS, accelerometer, gyroscope, or range finders (LiDAR or Time-of-Flight). In embodiments, a platform for providing first person perspective of experiences from a content creator wearing the wearable capture set 10 to a plurality of users, wherein each user can have a content display 206 with a hardware configuration wherein the platform can comprise the wearable capture set 10 comprising a plurality of sensors capturing environmental information and a transceiver.

Multiples of a particular sensor may be used to provide a depth of context. By capturing more data points from various perspectives, these arrays enable accurate 3D reconstruction, immersive audio, and a heightened sense of presence, making the augmented reality experience more engaging and lifelike. Multiple cameras placed at different angles can provide better depth perception and enable more accurate 3D reconstruction of the environment, can cover a wider field of view, capturing the content creator's surroundings from multiple angles. A dual-camera setup, simulating human binocular vision, can offer depth perception and enhance the realism of the content. Multiple cameras may also provide redundancy, ensuring that if one camera fails or is obstructed, the others can continue to capture essential visual information.

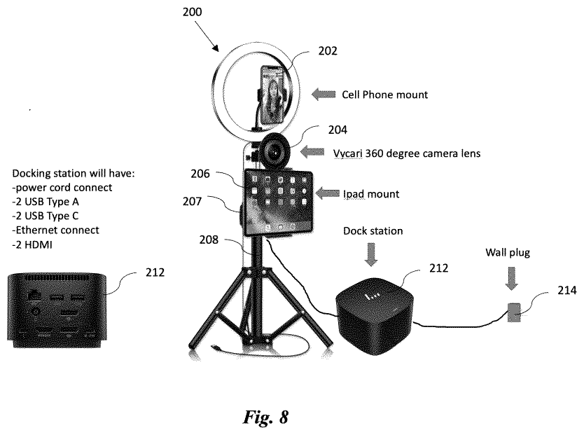

Referring to FIG. 8, in embodiments, a content consumer's system 200 can have a content display 206 which can be attached to a support device 208 and a second camera 202 can be attached above the content display on a support device 208 wherein the second camera can be such as, for example, between 90 degree to 360 degree lens and even more particularly 160 degree camera, capturing the surrounding area around it wherein the camera can be such as, for example, 360 camera, panoramic camera, dome camera, pan-tilt-zoom camera, surround view camera, spherical camera, multi-view camera, or the like. The mount 207 can be such as, for example, clamp mount, desktop stand, magnetic mount, tripod mount, ring mounts, or the like that can be sized to fit varying size portable computing device such as, a phone, tablet or the like. The support device 208 can be attached to the mount 207 wherein the support device can be such as, for example, tripod, bi-pod, monopod, video tripod, or the like. The support device 208 can adjust the second camera 202 to the user's height. The mount 207 can rotate horizontally and vertically allowing the user to set the optimal viewing angle. The mount 207 can further comprise a docking station 212 that can have at least one of such as, for example, at least one HDMI plugs, at least one USB type A and USB type C ports, ethernet connection, power cord, or the like wherein the docking station can be attached to a wall plug 214. The second camera 204 can recognize the user's head movement from left, right, up and down and can see the full scope of the content creator's feed. Multiple users can connect to the platform and can experience content in real-time, at the same time and can invite others via the application and each user can see the full scope of the content creator's feed.

The platform can have a server 210 in wireless communication with the transceiver that receives the information from the plurality of sensors and creates a content package conveying the first-person perspective of the content creator. A cloud-based application can relay the content package to the content displays 206 of the plurality of users. The content display 206 can be such as, for example, virtual reality headset, portable computing device, tablet, computing device, monitor, television, or the like. The content package can be relayed substantially in real time or in other embodiments can be delayed. The platform can include technical specifications of the content display and can tailor the content package to realistically reproduce the first person perspective at the content display 206 based on the hardware configuration of the content display from the wearable capture set 10.

Referring back to FIG. 1-5, the wearable capture set 10 can have an array of microphones that can capture audio from different directions, enabling spatial audio processing. Sounds may be reproduced so that users can perceive the direction and distance of sounds in relation to the content creator's perspective and at least one microphone can be configured to capture environmental information near the ear of the content creator. Noise cancellation algorithms can be applied to remove unwanted background noise and offer a 360-degree auditory experience. Users can hear sounds coming from various directions, enhancing the overall realism of the content. An array of microphones can help accurately locate the source of the content creator's voice, which is particularly useful in scenarios where the content creator is interacting with the environment or providing commentary.

A heart rate monitor or other biometric sensors may also be included to capture the physiological state of the content creator. The wearable 10 is in communication with the content creator's mobile device 50. The platform 100 may supplement the information from the wearable capture set 10 with information from the content creator's mobile device 50.

In a particular embodiment of the wearable capture set 10 as a pair of sunglasses is provided. The sunglasses 10 include a frame 22, lenses 24 and a pair of arms 32 connected to the frame via a hinge 23. A power switch 30 allows the user to power the capture set 10 on and off. Each arm 32 may have a hollow housing 35 for housing a battery 34. At least one arm 32 can have at least one of a battery life indicator 36, an antenna 37, a microphone 16, a chip 38 having a system or microprocessor, and a camera lens 14. A charging port 40 allows access for a charger to charge the battery 34, and a record button allows the content creator to selectively engage the capture set 10 to begin capturing data. The battery 34 can be such as, for example, lithium ion, alkaline, rechargeable, induction charging, nickel-cadmium, or the like. The record button 42 can be coupled to the arm 32, camera housing 39, or sunglass frame 22. The record button 42 can be such as, for example, push button, tactile button, membrane switch, or the like.

A camera housing 39 can be attached to at least one of the arms 32 wherein the camera housing can hold a camera, the battery life indicator LED 36, the antenna 37, and the camera lens 14 which can be removably attached to the camera or housing 39. The camera lens 14 can allow for a recording angle from such as, for example, 0 degrees to 360 degrees and even more particularly 45 degrees to 180 degrees. The hinge 23 can have a recording indictor 21 coupled to it or the recording indicator can be coupled to the arm 32 or camera housing 39. At least one wiring to connect the at least one camera together to the chip 38 wherein the chip can be such as, for example, system on a chip (“SoC”), internet of things SoC, wearable SoC, or the like.

A charging case 50 may be provided for the capture set 10 to protect and extend the battery life of the capture set 10. Various functions for the capture set may be built into common actions with the form of the capture set. The charging case 50 can comprise an interior shell 78 for the capture set to be placed in wherein the interior shell can have a protective cover such as, for example, micro-fibers, leather, neoprene, or the like. The interior shell 78 can be coupled to a rigid outer shell 86 wherein an onboard CPU 72 can be coupled between the interior shell and the outer shell. A rechargeable battery 74 can be coupled to the CPU 72 by a printed circuit board 76 and can be placed between the interior shell 78 and outer shell 86. The rechargeable battery 74 can be coupled to an induction charging which can charge the wearable capture set 10 while docked within the charging case 50. The charging case 50 can have a lid 82 that can flap or snap close which can have a power indicator 80 coupled to it allowing the user to see the battery level. The outer shell 86 can be such as, for example, plastic, metal, ceramics, composite, or the likes. The charging case 50 can recognize when the wearable capture set 10 is in the interior shell 78 and start charging the wearable capture set conserving the battery levels when not in the charging case.

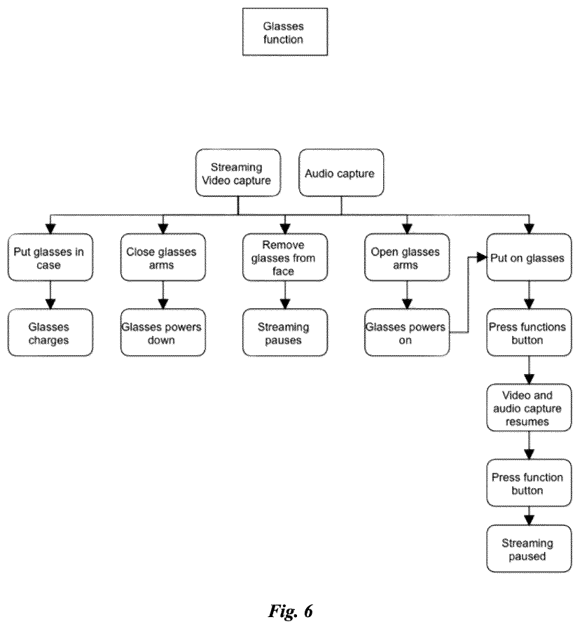

For example, referring to FIG. 6, when the capture set is a set of sunglasses, putting the glasses in the case may cause the case to charge the glasses, closing the arms of the glasses may power down the glasses, removing the glasses from the content creators face may pause the stream, opening the arms of the glasses may power the glasses on, and then putting on the glass and pressing a function button may cause video and audio capture to resume. Pressing the function again would pause the stream.

The mobile device is wirelessly coupled to the platform 100 via a Wi-Fi or cellular wireless connection, or any other wireless connection know to those having skill in the art. The platform 100 allows consumers to view the experiences of the content creator via a web application 102, a mobile device application 104, or a VR or AR product display 106. The platform may provide a VR or AR product display 106 that is specialized to the platform. The display 106 may have a series of speakers and video particularly designed to reproduce the experience of the content creator. The platform provides content creators with a simplified format to connect with users and provide and monetize content.

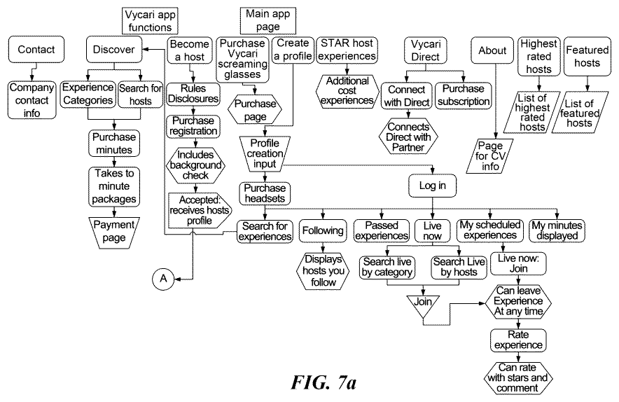

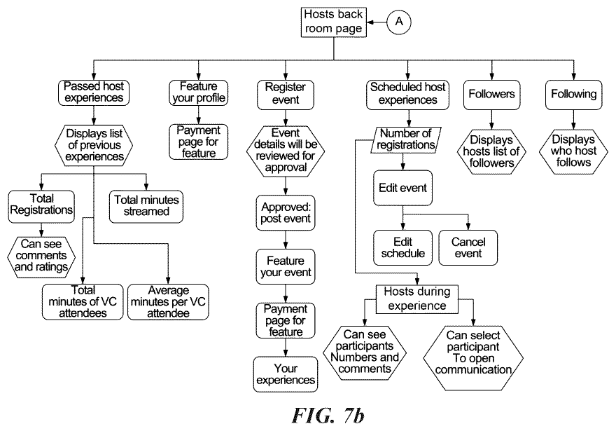

Referring to FIG. 7a-FIG. 7b, a flow diagram of the platform and connecting the wearable capture headset 10 to the content display 206 to content creators purchasing a wearable capture set 10 and can access the platform 100 online via a desktop or mobile application. The platform may provide a background check for content creators or users who view the content. Background checks may be automatically performed or may be performed by personnel on a case-by-case basis. The background check may verify a content creator or experiences that a content creator has listed as a part of their profile to prevent misinformation or fake content.

Content creators create an account to become a content host on the platform. The platform facilitates the creation of user profiles, allowing users to customize their profiles with profile pictures, bios, and personal information. Users can also set privacy preferences to control who can access their content and interact with them. Hosts are allowed to create a profile that users may view when searching for content to consume. The host may set their overall profile or certain pieces of content for limited distribution. It may be limited to a small group, or to a single user similar to a personal communication like a phone call or video chat. The host may also set the content to be shared more generally. Hosts may view their past host experiences including a display of previous experiences and data related to those experiences including, for example, total registrations, minutes streamed, minutes of VC attendees, and other data related to previous host experiences.

Content creators are also able to register new events on the platform. Event details are entered and reviewed for approval and upon approval the event is posted to the platform and may be found by content consumers. A payment page is provided to allow the content creator to set the terms of payment. The host can see the number of consumers that have registered for the event, edit the event or the event's schedule or cancel the event. Content consumers via the content consumer's system, as shown in FIG. 8, may follow a host and view new or promotional content from host they are following, or other hosts that a host follows.

Content consumers may also create a profile and may purchase content viewing headsets with special virtual reality features related to the platform. Hosts may also be content consumers of other hosts' content. Consumers may search for experiences and view the scheduled experiences of content creators that they are following. Consumers may re-experience previous live experiences or view a previously recorded experience that they have not seen previously. Consumers may also view a listing of experiences that are currently live and join an experience that is in progress. Consumers can leave an ongoing experience at any time, and may rate or comment on experiences that they are participating in or have shared in. The platform can allow the plurality of users, the consumers, to interact with the content creator during their experience wherein they are able to move their head wherein the second camera 204, from FIG. 8, can recognize the user's head movements and move the video feed on the content display 206.

The platform generates personalized feeds for content consumers, presenting them with content from hosts they follow, and content related to their interests. The feed may incorporate algorithms that prioritize content based on engagement, relevance, and user behavior. Users are provided with content discovery features that suggest new hosts to follow and recommend experiences based on their preferences and interactions. These recommendations enhance user engagement and introduce them to diverse content. The platform includes direct messaging features that allow hosts to communicate privately with content consumers. This function encourages one-on-one conversations, collaboration, and more direct sharing of adventurous experiences.

Content creators set the terms of payment to be able to join a live experience wherein a payment portal allows the content creator to design and implement payment terms for accessing the content package. The platform offers monetization features that allow content creators to earn revenue through advertising partnerships, sponsorships, and direct support from their audience. Users can also offer virtual gifts or tokens to content creators as a form of appreciation.

Content creators may set up viewing parties of previous experiences with the same group of users who shared the original experience or with some other group of users. The content creator may create a commentary to go along with the original experience as a sort of director's cut commentary. Any interactions between users and the content creator can be reproduced at each content display of the plurality of users to create a shared experience for the content creator and the plurality of users

Content creators are provided with insights into the performance of their hosted experiences, including metrics such as views and engagement rates. This data helps users understand their audience and optimize their content strategy. The data may include, without limitation, demographic information such as age, gender, location, language, and other basic demographics, user engagement metrics, content consumption patterns, follower/friend relationships, search queries, location data, device information, app usage behavior, ad interaction and targeting, time of activity, messaging and communications patterns, user preferences and setting, and account creation and authentication data.

In embodiments, the method for sharing a first-person perspective of an experience to multiple users in real time, the method can comprise providing the platform using the wearable capture set 10, capturing the environmental information about the experience through the plurality of sensors wherein the environmental information can be transmitted from the sensors. A content package can be created reflecting the first-person perspective of the content creator wherein the content package can be relayed to a content display of each of the multiple users. The method can further comprise providing a payment portal that allows the content creator to design and implement payment terms for access to the content package, restricting access to the content package, and providing the content package on demand when the payment terms have been satisfied

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A platform for providing first person perspective of experiences from a content creator to a plurality of users, each user having a content display with a hardware configuration, the platform comprising:
a capture set comprising a plurality of sensors capturing environmental information and a transceiver;
a server in wireless communication with the transceiver that receives the information from the plurality of sensors and creates a content package conveying the first-person perspective of the content creator; and
a cloud-based application that relays the content package to the content displays of the plurality of users.

2. The platform of claim 1 wherein the content package is relayed substantially in real time.

3. The platform of claim 1 wherein the platform includes the technical specifications of the content display and tailors the content package to realistically reproduce the first-person perspective at the content display based on the hardware configuration of the content display.

4. The platform of claim 1 wherein the plurality of sensors comprises at least one camera configured to capture environmental information near the eyes of the content creator, and at least one microphone configured to capture environmental information near the ear of the content creator.

5. The platform of claim 4, wherein the capture set is a pair of glasses having a frame, a first arm, and a second arm, wherein each arm houses a camera and a microphone.

6. The platform of claim 1, wherein the content display is at least one of a desktop monitor and speakers, a virtual reality headset, and a mobile device display.

7. The platform of claim 2, wherein the platform allows the plurality of users to interact with the content creator during the experience.

8. The platform of claim 7, wherein any interactions between users and the content creator are reproduced at each content display of the plurality of users to create a shared experience for the content creator and the plurality of users.

9. The platform of claim 1 further comprising a payment portal that allows the content creator to design and implement payment terms for access to the content package.

10. The platform of claim 7 further comprising a content consumers system wherein the content consumer's system has a support device and a second camera wherein the second camera is coupled to a mount wherein the content display is coupled to a docking station and the second camera.

11. The platform of claim 10 wherein the second camera recognizes the content consumer's head movements and the content display shows the view from the content creator in real-time as the content consumer's head moves.

12. A method for sharing a first-person perspective of an experience to multiple users in real time, the method comprising:
providing the platform of claim 1;
capturing the environmental information about the experience through the plurality of sensors;
transmitting the environmental information to the server;
creating a content package reflecting the first-person perspective of the content creator;
relaying the content package to a content display of each of the multiple users.

13. The method of claim 12 further comprising providing a payment portal that allows the content creator to design and implement payment terms for access to the content package, restricting access to the content package, and providing the content package on demand when the payment terms have been satisfied.
